(19) United States
(12) Patent Application Publication
(10) Pub. No.: US 2026/0186614 A1
(43) Pub. Date: Jul. 2, 2026

(54) CONTROL METHOD AND ELECTRONIC DEVICE

(71) Applicant: Lenovo (Beijing) Limited, Beijing (CN)

(72) Inventors: Bingyu HUANG, Beijing (CN); Binqiang MA, Beijing (CN)

(21) Appl. No.: 19/429,227

(22) Filed: Dec. 22, 2025

(30) Foreign Application Priority Data
Dec. 31, 2024 (CN) 202411997370.7

(51) Int. Cl. G06F 3/0481; G06F 1/16; G06F 9/451

(52) U.S. Cl. CPC G06F 3/0481; G06F 1/1641; G06F 9/451; G06F 2203/04803

(57) ABSTRACT

A control method includes obtaining a device form of a display device, and in response to the display device being in a first device form or a second device form, controlling the display device to be in a corresponding split-screen mode. In the corresponding split-screen mode, the display device is divided into at least two display regions. The display regions are configured to display application windows. The first device form is different from the second device form. A split-screen mode corresponding to the first device form is different from a split-screen mode corresponding to the second device form.

### CROSS-REFERENCES TO RELATED APPLICATION

This application claims priority to Chinese Patent Application No. 202411997370.7, filed on December 31, 2024, the entire content of which is incorporated herein by reference.

### FIELD OF TECHNOLOGY

The present disclosure relates to the computer technology field and, more particularly, to a control method and an electronic device.

### BACKGROUND

Currently, in a device such as a laptop having a display, display dimension detection needs to be performed. Then, positions and dimensions of display windows are adjusted according to the display dimension.

### SUMMARY

One aspect of this disclosure provides a control method. The method includes obtaining a device form of a display device, and in response to the display device being in a first device form or a second device form, controlling the display device to be in a corresponding split-screen mode. In the corresponding split-screen mode, the display device is divided into at least two display regions. The display regions are configured to display application windows. The first device form is different from the second device form. A split-screen mode corresponding to the first device form is different from a split-screen mode corresponding to the second device form.

Another aspect of this disclosure provides an electronic device, including a display device, one or more processors, and one or more memories. The one or more memories store a computer program that, when executed by the one or more processors, causes the one or more processors to obtain a device form of a display device, and in response to the display device being in a first device form or a second device form, control the display device to be in a corresponding split-screen mode. In the corresponding split-screen mode, the display device is divided into at least two display regions. The display regions are configured to display application windows. The first device form is different from the second device form. A split-screen mode corresponding to the first device form is different from a split-screen mode corresponding to the second device form.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic flowchart of a control method according to some embodiments of the present disclosure.

FIG. 2 is a schematic diagram showing region areas of a first device form and a second device form according to some embodiments of the present disclosure.

FIG. 3 is a schematic diagram showing a second display being a scroll structure according to some embodiments of the present disclosure.

FIG. 4 is a schematic diagram showing a second display being a foldable tablet structure according to some embodiments of the present disclosure.

FIG. 5 is a schematic diagram showing a second display being folded relative to a first display according to some embodiments of the present disclosure.

FIG. 6 is a schematic diagram showing a second display being a slidable tablet structure according to embodiments of the present disclosure.

FIG. 7 is a schematic diagram of controlling a split display mode based on a device form according to some embodiments of the present disclosure.

FIG. 8, FIG. 9, and FIG. 10 are schematic diagrams of a one-key mode switch according to some embodiments of the present disclosure.

FIG. 11, FIG. 12, FIG. 13, FIG. 14, and FIG. 15 are schematic diagrams of controlling a display of a new application window according to some embodiments of the present disclosure.

FIG. 16, FIG. 17, FIG. 18, FIG. 19, and FIG. 20 are schematic diagrams of display of a display split application according to some embodiments of the present disclosure.

FIG. 21 is a schematic structural diagram of a control apparatus according to some embodiments of the present disclosure.

FIG. 22 is a schematic structural diagram of an electronic device according to some embodiments of the present disclosure.

FIG. 23 is a schematic diagram showing a display of an APP with a scroll display in a roll-out state in a scroll display scenario according to some embodiments of the present disclosure.

FIG. 24 is a schematic diagram showing a display of an APP with a scroll display in a roll-in state in a scroll display scenario according to some embodiments of the present disclosure.

FIG. 25 and FIG. 26 are schematic diagrams showing a one-key adjustment and layout in a scroll screen scenario.

### DETAILED DESCRIPTION

The technical solutions of embodiments of the present disclosure are described in detail in connection with the accompanying drawings of embodiments of the present disclosure. Apparently, the described embodiments are merely some embodiments of the present disclosure, not all embodiments. Based on embodiments of the present disclosure, all other embodiments obtained by those of ordinary skill in the art without creative efforts are within the scope of the present disclosure.

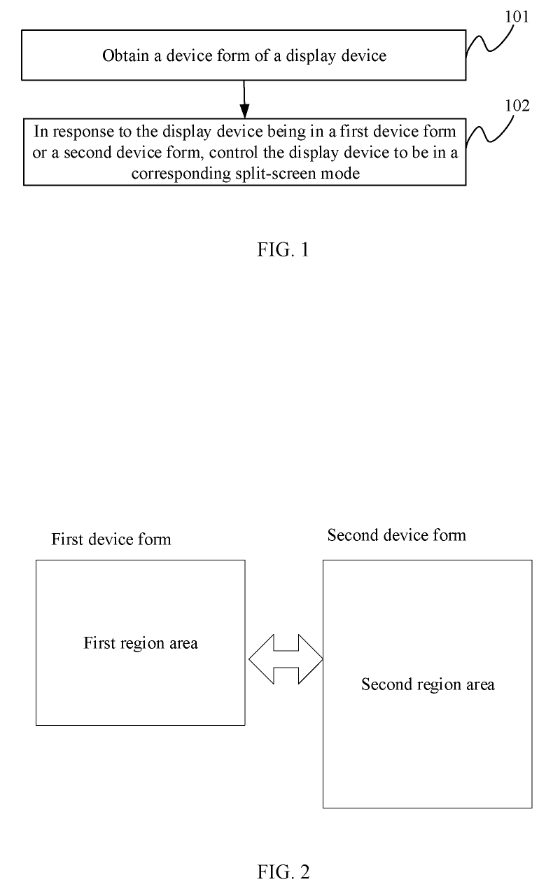

FIG. 1 is a schematic flowchart of a control method according to some embodiments of the present disclosure. The method can be applied to an electronic device having a display device, such as a notebook computer or a tablet device. The technical solution of embodiments of the present disclosure is used to realize control of a split-screen mode.

In some embodiments, the method of the present disclosure includes the following steps.

At 101, a device form of the display device is obtained.

The display device can include at least two display screens, such as a first display screen and a second display screen. The device form of the display device can be determined based on the relative position between the display screens included in the display device. For example, the first display screen and the second display screen can form a first device form or a second device form through a change in relative position. The first device form and the second device form can be different.

In some embodiments, the first device form and the second device form can have different region areas. For example, the area of a first region area corresponding to the first device form can be greater than a second region area corresponding to the second device form. As shown in FIG. 2, the first region area is the display region area of the display device under the first device form, and the second region area is the display region area of the display device under the second device form. Based on this, in some embodiments, by obtaining the device form of the display device, the display region area realized by the display device can be determined.

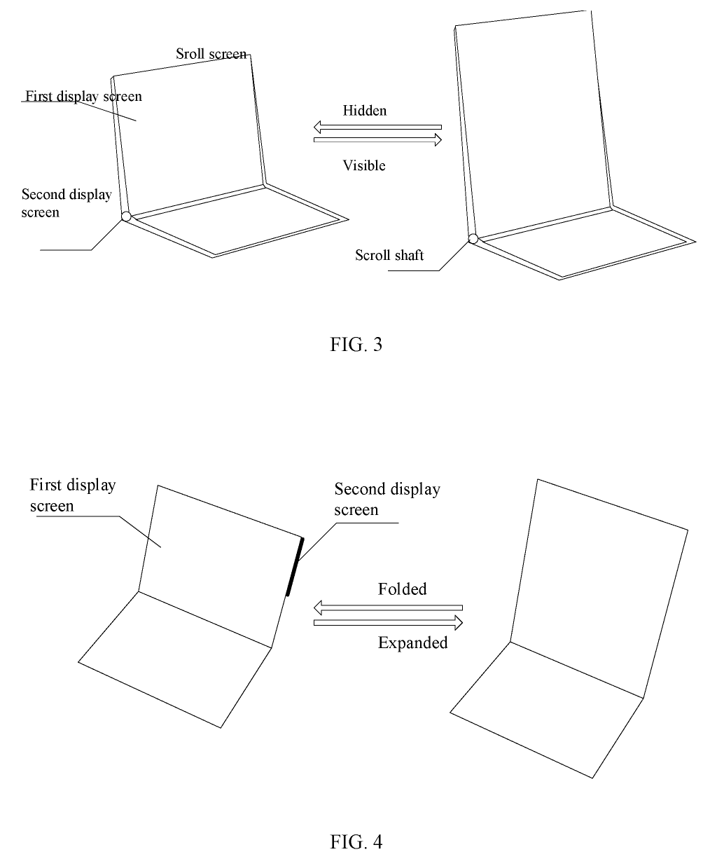

In some embodiments, the second display screen can be a scroll structure. For example, the display device can be a scroll-screen device. Based on this, under the second device form, the second display screen can be hidden inside the housing of the scroll structure. As shown in FIG. 3, under the first device form, the first display screen and the second display screen are in a visible state.

In some other embodiments, the second display screen can be a foldable tablet structure, and the second display screen can be connected to the first display screen in a foldable manner. For example, as shown in FIG. 4, under the first device form, the second display screen is unfolded relative to the first display screen, and under the second device form, the second display screen is folded relative to the first display screen.

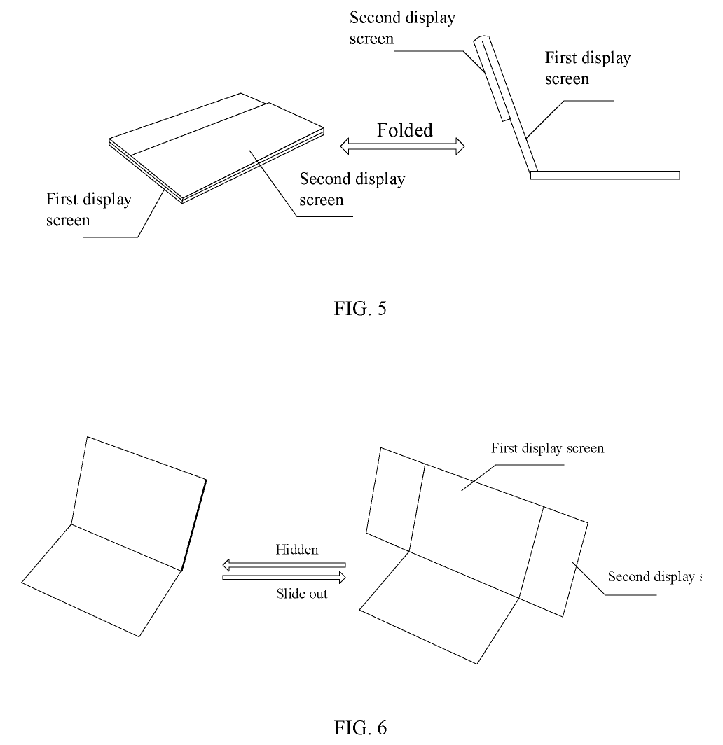

The first display screen and the second display screen can be folded through adjacent edges. Under the second device form, the back surface of the second display screen and the back surface of the first display screen can be attached to each other, and a display surface of the second display screen and a display surface of the first display screen can face away from each other. FIG. 5 illustrates two forms of the second display screen folded relative to the first display screen.

In some embodiments, the second display screen can be a slidable tablet structure. One or more second display screens can be included. The second display screen and the first display screen can have a folded structure. The second display screen can be blocked by the first display screen under the second device form. As shown in FIG. 6, a second display screen is provided on each of the right and left sides of the first display screen. The second display screen can slide out relative to the first display screen under the first device form.

The first display screen and the second display screen can slide relatively through a track to cause the second display screen to slide to the back surface of the first display screen under the first device form, and the first display screen to slide out from the back surface of the first display screen under the second device form. Then, the second display screen can be adjacent to the edge of the first display screen to form an entire display screen.

In some embodiments, a target instruction can be sent to the controller connected to the display device to receive the device form of the display device fed back by the controller in response to the target instruction.

For example, the central processing unit (CPU) of the laptop can send the target instruction to an embedded controller (EC) and a basic input output system (BIOS). The target instruction can be used to indicate the current device form of the scroll screen of the laptop, e.g., a roll-out state or a roll-in state. Based on this, the CPU can receive the device form fed back by the EC and BIOS.

At 102, in response to the display screen being in the first device form or the second device form, the display device is controlled to be in a corresponding split-screen mode.

Under the split-screen mode, the display device can be divided into at least two display regions. The display region can be used to display at least one application window.

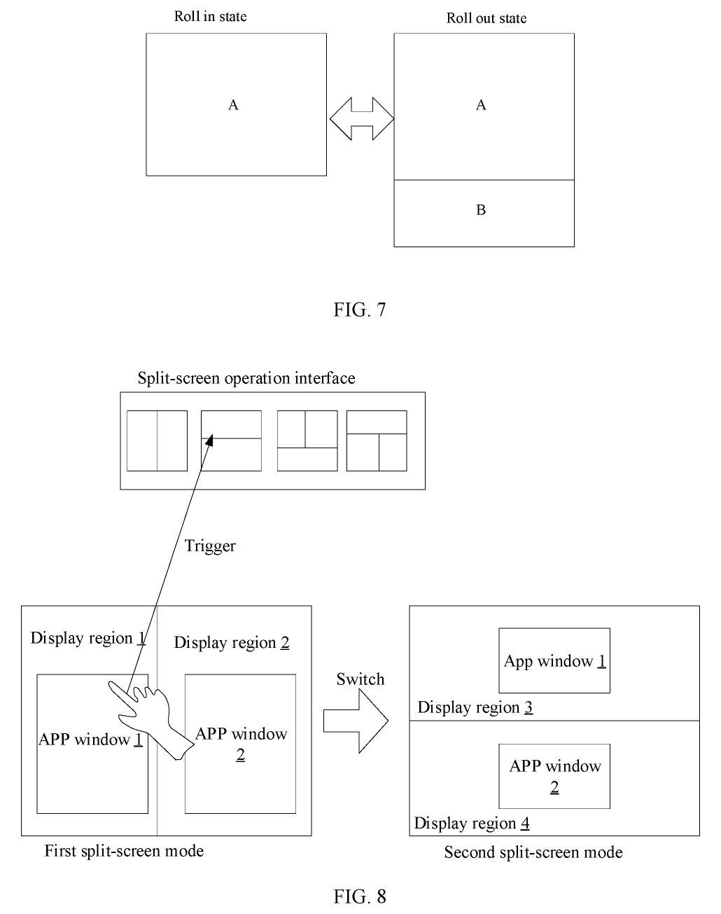

For example, as shown in FIG. 7, the scroll screen device includes a roll-in state and a roll-out state. Under the roll-in state, the scroll screen device displays at least one application window in display region A. Under the roll-out state, the scroll screen device displays at least one application window in each of the display region A and display region B.

From the above technical solution, in the control method of embodiments of the present disclosure, according to the first device form or the second device form of the display device, the display device can be controlled to be in a corresponding split-screen mode. In the split-screen mode, the display device can be divided into at least two display regions. The display region can be configured to display an application window. Since the first device form is different from the second device form, the split-screen mode corresponding to the first device form can be different from the split-screen mode corresponding to the second device form. Thus, the dimension detection may not be needed in embodiments of the present disclosure. The split-screen mode of the display device can be controlled according to the device form of the display device.

In some embodiments, in response to the split-screen switch operation for the first application window, the display device can be controlled to switch from the first split-screen mode to the second split-screen mode, and the first application window can be switched from the first display region to the third display region for display. Then, the second application window can be switched from the second display region to the fourth display region for display.

Based on this, in embodiments of the present disclosure, the user may only need to perform the split-screen switch operation on the first application window. The remaining second application window can be automatically displayed in the corresponding display region without the switch operation such as dragging performed by the user. Thus, the user operation process can be reduced to improve the screen splitting efficiency by lowering the operation complexity.

The first application window can be an application window displayed in the first display region of the display device. The first display region and at least one second display region of the display device can form the first split-screen mode. The second display region can display the second application window. In the second split-screen mode, the display device can be divided into a third display region and at least one fourth display region. At least two display regions between the first split-screen mode and the second split-screen mode can have different layout positions.

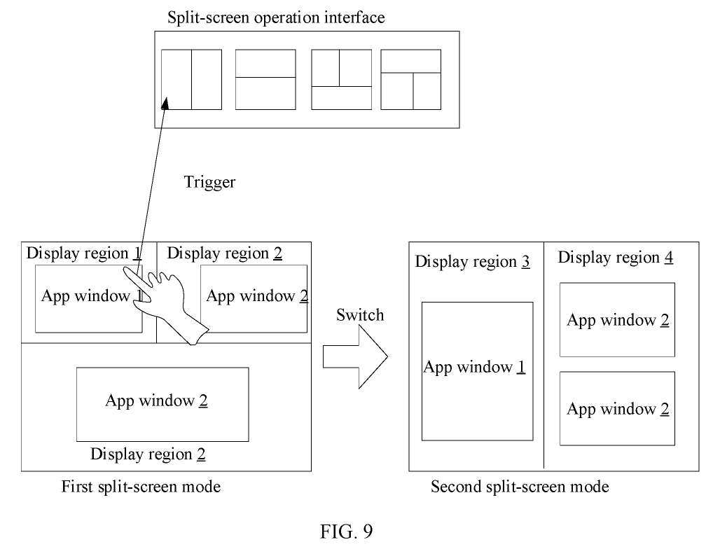

For example, as shown in FIG. 8, in the first split-screen mode, the first display region and the second display region split the screen into left and right screens. Under the second split-screen mode, the first display region and the second display region split the screen into up and down screens. Under the first split-screen mode, the user can drag application window 1 in display region 1 to trigger a split-screen operation interface. The split-screen operation interface can display window thumbnails corresponding to a plurality of split-screen modes, e.g., window thumbnails of up and down split-screens, left and right split-screens, up two and down one split-screens, and up one and down two split-screens. Then, the user can drag application window 1 to the upper region of the up and down split-screens in the window thumbnail corresponding to the second split-screen mode. Thus, the display device can be switched from the left and right split-screens to the up and down split-screens. Moreover, application window 1 is displayed in display region 3 at the upper side. Application window 2 in display region 2 is displayed in display region 4 at the lower side. In this process, the user does not need to drag the application window 2. Then, the mode switch can be done by one key to reduce the operation processes of the user, and the split-screen efficiency can be improved by lowering the operation complexity.

Based on the above, if the number of display regions under the first split-screen mode is greater than the number of display regions under the second split-screen mode, an application window in each display region under the first split-screen mode can be switched to each display region under the second split-screen mode. Application windows in the remaining display regions under the first split-screen mode can be switched to one display region under the second split-screen mode, which can be tiled or stacked with the existing application window in the display region.

For example, as shown FIG. 9, under the first split-screen mode, the first display region and the second display region are in a up two and down one split-screen mode. Under the second split-screen mode, the first display region and the second display region are in a left-right split-screen mode. Under the first split-screen mode, the user drags application window 1 in display region 1 to trigger the split-screen operation interface. Then, the user drags application window 1 to the upper-left region of the up two and down one split-screen thumbnail corresponding to the second split-screen mode. Then, the display device switches from the up two and down one split-screen mode to the left-right split-screen mode, and application window 1 is displayed in the display region 3 at the upper side, while the application windows 2 in the remaining two display regions 2 are tiled in the right display region 4. During this process, the user may not need to drag the application window 2, thereby realizing a one-key mode switch. Thus, the user operation processes can be reduced and the split-screen efficiency can be improved by lowering the operation complexity.

Based on the above, if the number of display regions in the first split-screen mode is smaller than the number of display regions in the second split-screen mode, the application windows in each display region under the first split-screen mode can be switched to each display region under the second split-screen mode, while some display regions under the second split-screen mode may not display an application window.

For example, as shown in FIG. 10, under the first split-screen mode, the first display region and the second display region are in a left-right split-screen mode. Under the second split-screen mode, the first display region and the second display region are in up one and down two split-screens. Under the first split-screen mode, the user drags the application window 1 in the display region 1 to trigger the split-screen operation interface. Then, the user drags application window 1 to the upper region of the up one and down two split-screens in the split-screen thumbnail corresponding to the second split-screen mode. Then, the display device switches from the left-right split-screen mode to the up one and down two split-screen. Application window 1 is displayed in the display region 3 at the upper side, while application window 2 in display region 2 is displayed in the lower-left display region 4, and the lower-right display region 4 does not include an application window. During this process, the user may not need to drag the application window 2, thereby realizing the one-key mode switch and reducing the user operation process. Thus, split-screen efficiency can be improved by lowering the operation complexity.

In some embodiments, in response to a trigger display operation for a third application window, the third application window can be displayed in at least a portion of a target display region.

In some embodiments, the target display region in the display device may not display the application window. That is, the newly opened third application window can be displayed in a blank display region without displaying an application window in the display device.

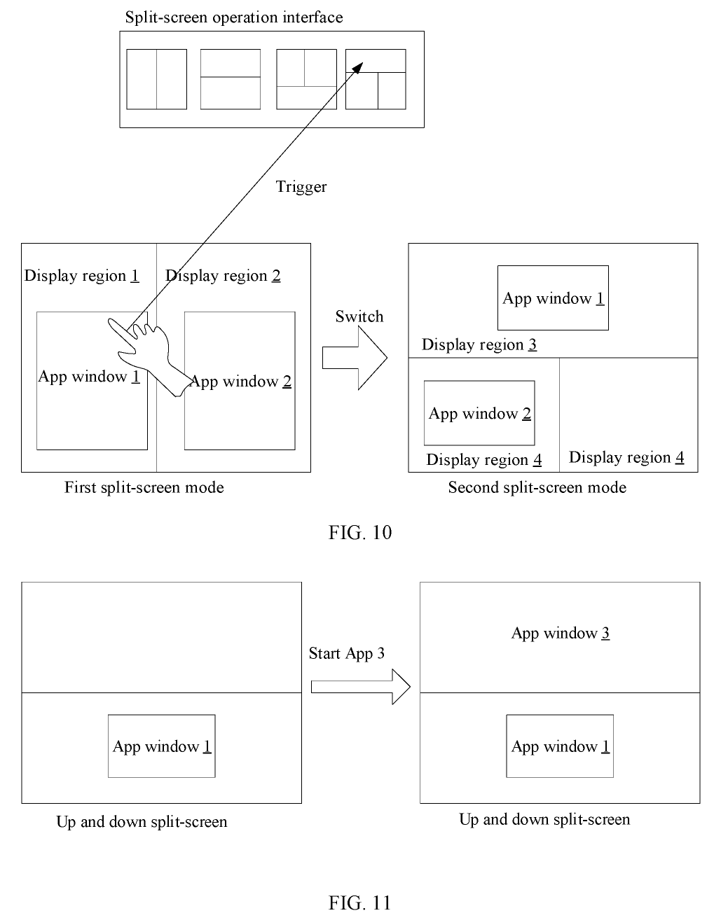

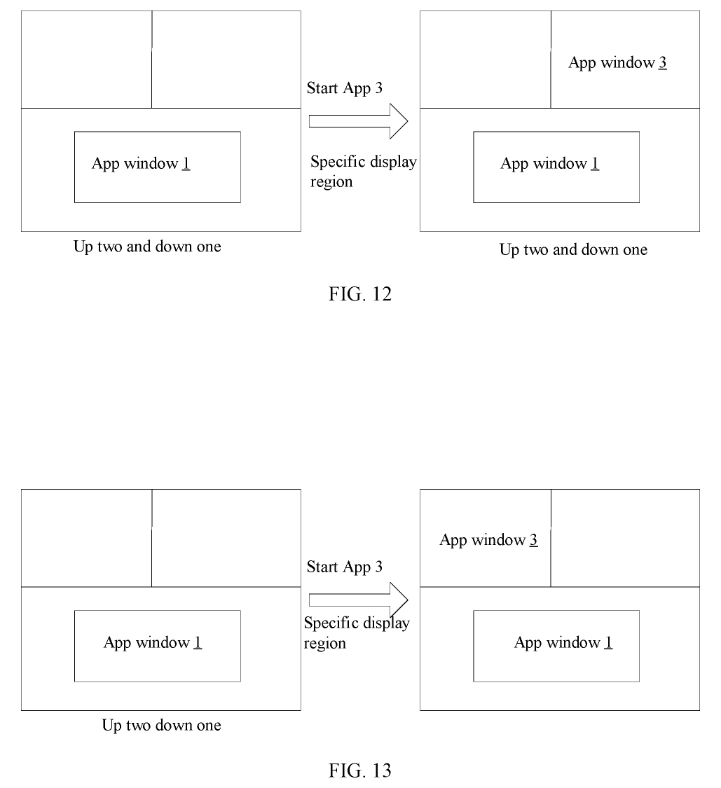

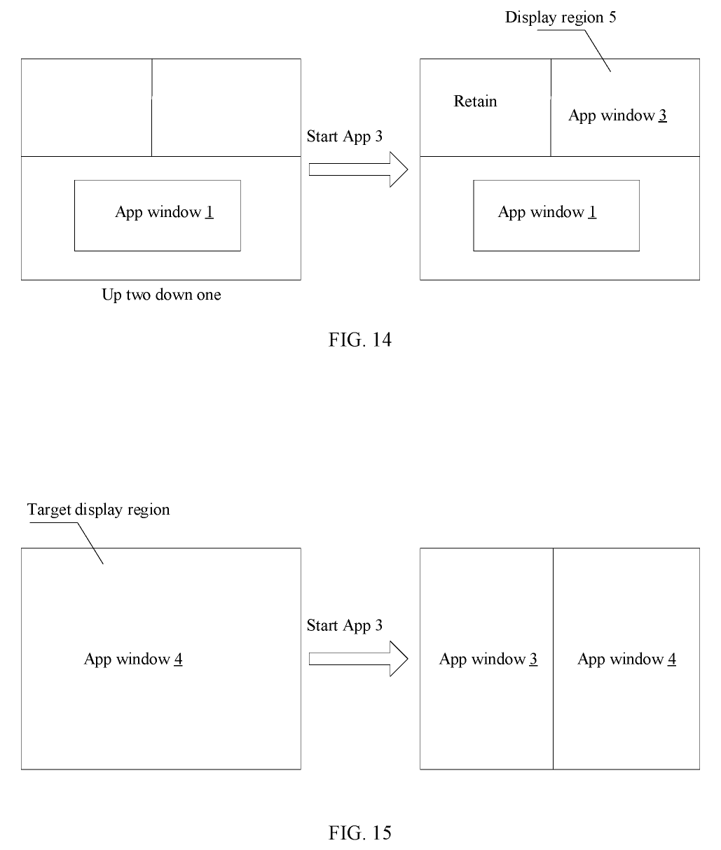

For example, as shown in FIG. 11, under the up and down split-screen mode, the bottom display region displays the application window 1, and the upper display region does not display an application window. The user clicks on the application icon of the application 3 to start the application 3. The application window 3 of the application 3 is displayed in the upper display region.

In some other embodiments, the relative position of the target display region in the display device can satisfy a position condition. That is, the newly opened third application window can be displayed in a display region at a certain position in the display device.

For example, as shown in FIG. 12, under the up two and down one split-screen mode, the bottom display region displays the application window 1. The upper left display region and the upper right display region do not display an application window. The user clicks on the application icon of the application 3 to start the application 3. The application window 3 of the application 3 is displayed in the upper right display region.

In some other embodiments, the relative position of the target display region in the display device can match the trigger display operation. That is, the newly opened third application window can be displayed in a display region specified by the trigger display operation in the display device.

For example, as shown in FIG. 13, under the up two and down one split-screen mode, the bottom display region displays the application window 1. The upper left display region and the upper right display region do not display an application window. The user clicks on the application icon of application 3 and specifies the upper left display region. Based on this, after the application 3 is started, the application window 3 of the application 3 is displayed in the upper left display region.

In some other embodiments, the target display region can be different from a fifth display region in the display device. The fifth display region can be configured to display the application window of the first application. That is, the newly opened third application window can be displayed in any other display region, excluding the specified display region in the display device.

For example, as shown in FIG. 14, under the up two and down one split-screen mode, the bottom display region displays the application window 1, and the upper left display region and the upper right display region do not display any application window. However, the upper display regions are retained and configured to display application windows of office applications. The user clicks the application icon of the application 3. After the application 3 is started, the application window 3 of the application 3 is displayed in the display region 5 at the upper right side.

Based on the above, when the third application window is displayed in at least a portion of the target display region, the following situations can be included.

In some embodiments, the third application window can be displayed in the whole region of the target display region. As shown in FIG. 11 to FIG. 14, application window 3 occupies the whole region of the display region.

In some other embodiments, the third application window can be displayed in a first sub-region of the target display region.

A second sub-region of the target display region can be configured to display the fourth application window. The fourth application window can be an application window displayed in the target display window before the third application window is displayed.

For example, as shown in FIG. 15, the application window 3 occupies a portion of the region on the left side of the target display region. The application window 4 is switched from occupying the whole region of the target display region to occupying a portion of the region on the right side of the target display region.

In some embodiments, when the display device is under the first device form, the display device can be in the first split-screen mode.

Under the first split-screen mode, the display device can display a sixth display region. The sixth display region can be configured to display the application window of the second application. The application window of the second application can be configured to display at least one application window.

In some embodiments, the second application can, through container construction, allow the application window of the second application to display application windows of one or more other applications.

In some embodiments, the sixth display region can be a display region expanded by the display device under the first device form relative to the second device form.

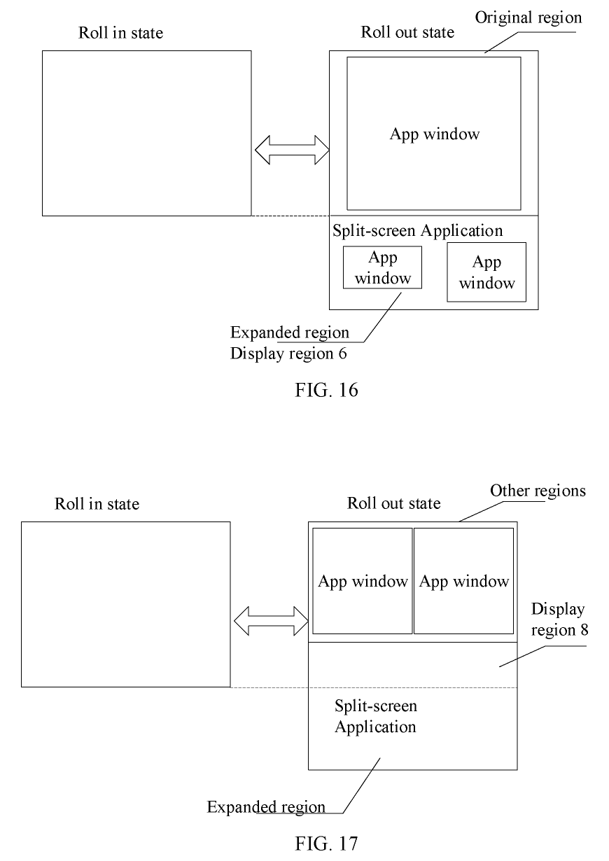

For example, as shown in FIG. 16, the first device form is a roll-out status of a scroll screen. Under the roll-out status, the roll-out portion of the scroll screen can be an expanded region. The expanded region can be adjacent to the original region displayed by the scroll screen under the roll-in status. The expanded region can be a display region 6. The display region 6 can be configured to display the application window of the split-screen application. The application window of the split-screen application can display one or more application windows. Then, the original region of the scroll screen, the display region 6, and the original region can form the first split-screen mode. The original region can be configured to display application windows of one or more applications.

In some other embodiments, the sixth display region can include the display region expanded by the display device under the first device form relative to the second device form. Moreover, the eighth display region can be a display region expanded by the display device adjacent.

For example, as shown in FIG. 17, the first device form can be the roll-out status of the scroll screen. In the roll-out form, the roll-out portion of the scroll screen can include an expanded region. The expanded region is adjacent to the original region displayed by the scroll screen in the roll-in state. The expanded region and the portion of the original region adjacent to the expanded region, i.e., the display region 8, form the display region 6. The display region 6 is configured to display the application window of the split-screen application. One or more application windows can be displayed in the application window of the split-screen application. The other regions, excluding the display region 8, in the original region can be configured to display the one or more application windows.

Based on the above, in response to the layout switch operation of the first split-screen mode, the display device can be controlled to switch from the first window layout to the second window layout.

The first layout position can match the second layout position. The first layout position can be the layout position of the sixth display region in the first window layout. The second layout position can be the layout position of the sixth display region in the second window layout. The first layout position matching the second layout position can include the first layout position and the second layout position having the same relative position in the display device. For example, the first layout position and the second layout position can be at the bottom region of the display device.

In some embodiments, the layout switch operation can be the operation performed on the window layout switch under the first split-screen mode.

For example, as shown in FIG. 18, under the roll-out state of the scroll screen, the scroll screen expands to form the display region 6. When the user switches the up and down window layout into the up two and down one window layout under the first split-screen, the display region 6 wherein the split-screen is always in the bottom display region of the scroll screen. The application window of the split-screen application in the display region 6 displays the one or more application windows.

Based on the above, in response to the adjustment operation for the sixth display region, the region position of the adjusted sixth display region can be obtained. Then, according to the region position of the sixth display region after being adjusted, the display position of each application window can be adjusted in the sixth display region.

The adjustment operation can be an operation of adjusting the region position of the sixth display region under the first split-screen mode. The region position can be the relative position of the sixth display region in the display device. The region position can indicate the region dimension of the sixth display region.

In some embodiments, the application windows can be stacked in layers in the sixth display region.

For example, as shown in FIG. 19, the user adjusts the dimension and position of the display region 6, such that the display region 6 changes from occupying one-third of the full screen to one-half of the full screen. As a result, based on two overlapping application windows within the display region 6, the topmost application window occupies the entire display region 6, and the window dimensions of the application windows within the display region 6 can be expanded as the dimension of the display region 6 is expanded.

In some other embodiments, the application windows can cover the whole sixth display region, and the application windows do not overlap with each other.

For example, as shown in FIG. 20, the user adjusts the dimension and position of the display region 6, so that the display region 6 changes from occupying one-third of the full screen to one-half of the full screen. As a result, based on the two non-overlapping application windows within the display region 6 that cover the full display region 6 without overlapping with each other, the dimensions of the application windows within the display region 6 can be expanded as the dimension of the display region 6 is expanded.

Thus, in embodiments of the present disclosure, when the user adjusts the region position of the display region where the second application is located, the display position of the application window in the display region can be adjusted automatically, and the user may not need to perform the window adjustment operation. Thus, the user operation processes can be reduced, and the efficiency of splitting the screen can be improved by reducing the operation complexity.

Based on the above implementation, in some embodiments, the region position of the seventh display region can be adjusted according to the region position of the adjusted sixth display region.

The seventh display region can be any display region within the display device other than the sixth display region. The seventh display region and the sixth display region can cover the whole display device together, and the seventh and sixth display regions do not overlap with each other.

Furthermore, after the region position of the seventh display region is adjusted, the region positions of the application windows tiled within the seventh display region can be synchronously adjusted.

For example, as shown in FIG. 19 and FIG. 20, the display device is divided into the display region 7 and the display region 6. When the region position of the display region 6 is adjusted, the region position of the display region 7 is synchronously adjusted. That is, the region dimension is shrunk. The display region 7 and the display region 6 do not overlap with each other. Further, the window dimension of the application window I the display window 7 is synchronously reduced.

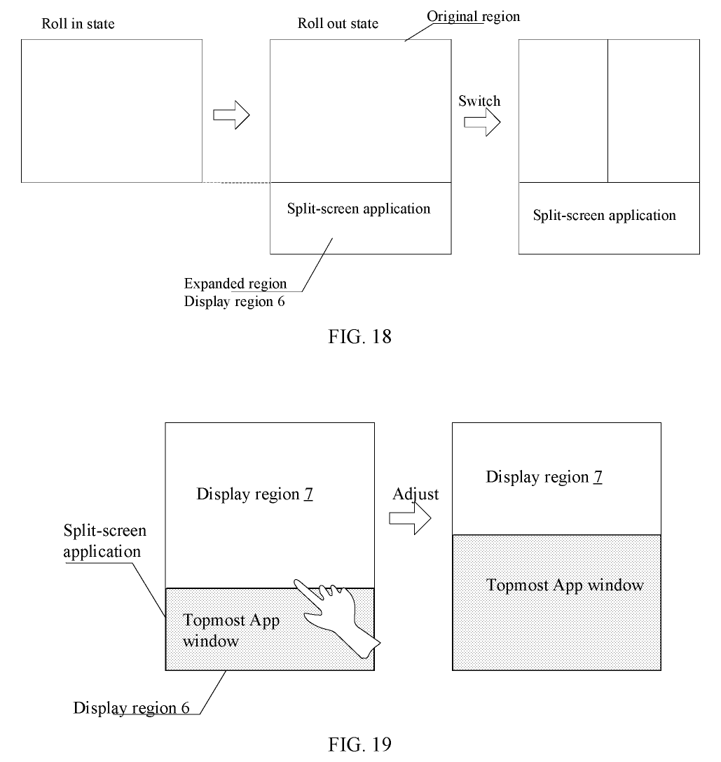

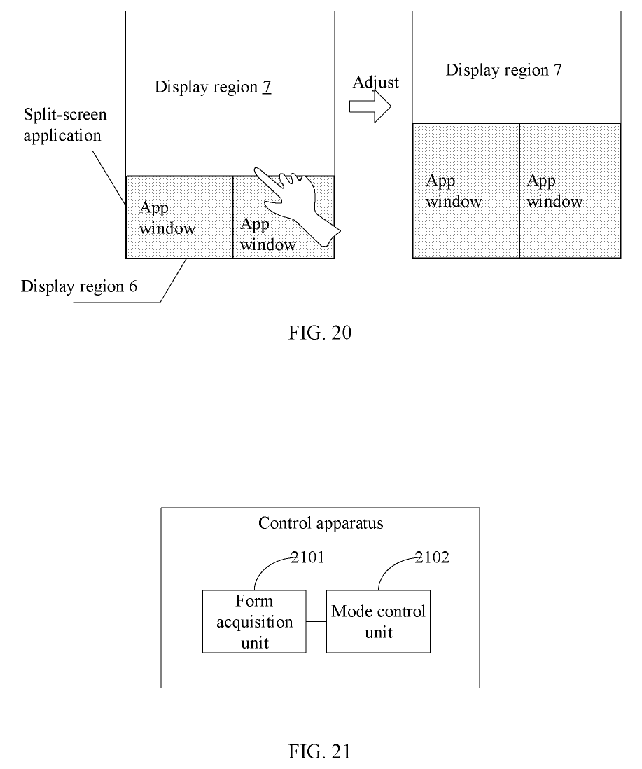

FIG. 21 is a schematic structural diagram of a control apparatus according to some embodiments of the present disclosure. The apparatus can be deployed in an electronic device with a display device, such as a laptop or tablet device. The technical solution of embodiments of the present disclosure is mainly used to realize the control of the split-screen modes.

In some embodiments, the apparatus includes a form acquisition unit 2101 and a mode control unit 2102.

The form acquisition unit 2101 can be configured to obtain the device form of the display device.

The mode control unit 2102 can be configured to, in response to the display device being in a first device form or a second device form, control the display device to be in the corresponding split-screen mode.

Under the split-screen mode, the display device can be divided into at least two display regions. The display regions can be configured to display application windows. The first device form can be different from the second device form. The split-screen mode corresponding to the first device form can be different from the split-screen mode corresponding to the second device form.

From the above technical solution, in the control apparatus of embodiments of the present disclosure, according to the first device form or the second device form of the display device, the display device can be controlled to be in the corresponding split-screen mode. Under the split-screen mode, the display device can be divided into at least two display regions. The display region can be configured to display the application windows. Since the first device form is different from the second device form, the split-screen mode corresponding to the first device form can be different from the split-screen mode corresponding to the second device form. In some embodiments, the dimension detection may not be needed, and the split-screen mode of the display device can be controlled according to the device form of the display device.

In some embodiments, the mode control unit 2102 can be further configured to, in response to a split-screen switching operation for the first application window, control the display device to switch from the first split-screen mode to the second split-screen mode, and switch the first application window from being displayed in the first display region to the third display region. The first application window can be the application window displayed in the first display region in the display device. The first display region and the at least one second display region in the display device can form the first split-screen mode. The second display region can display the second application window. Under the second split-screen mode, the display device can be divided into the third display region and the at least one fourth display region. At least two display regions can have different layout positions between the first split-screen mode and the second split-screen mode. The second application window can be switched from the second display region to the fourth display region for display.

In some embodiments, the mode control unit 2102 can be further configured to, in response to the trigger display operation for the third application window, display the third application window in at least a portion of the target display region. The target display region can satisfy at least one of the following conditions in the display device. The target display region does not display application windows. The relative position of the target display region in the display device satisfies the position condition. The relative position of the target display region in the display device matches the trigger display operation. The target display region is different from the fifth display region in the display device. The fifth display region is configured to display the application window of the first application.

In some embodiments, the mode control unit 2102 can display the third application window in the at least a portion of the target display region. The mode control unit 2102 can be configured to display the third application window in the whole target display region, or display the third application window in a first sub-region in the target display region. The second sub-region of the target display region can be configured to display the fourth application window. The fourth application window can be the application window displayed in the target display region before the third application window is displayed.

When the display device is in the first device form, the display device can be in the first split-screen mode. Under the first split-screen mode, the display device can display the sixth display region. The sixth display region can be configured to display an application window of the second application. The application window of the second application can be configured to display at least one application window.

In some embodiments, the mode control unit 2102 can be further configured to, in response to a layout switching operation for the first split-screen mode, control the display device to switch from the first window layout to the second window layout. The first layout position can match the second layout position. The first layout position can be the layout position of the sixth display region in the first window layout. The second layout position can be the layout position of the sixth display region in the second window layout.

In some embodiments, the mode control unit 2102 can be further configured to, in response to an adjustment operation for the sixth display region, obtain the region position of the adjusted sixth display region, and, according to the region position of the adjusted sixth display region, adjust the display position of each application window within the sixth display region. The application windows can cover the whole sixth display region, and the application windows may not overlap with each other.

In some embodiments, the mode control unit 2102 can be further configured to adjust the region position of the seventh display region according to the region position of the adjusted sixth display region. The seventh display region can be any display region in the display device other than the sixth display region. The seventh display region and the sixth display region can cover the whole display device. The seventh display region and the sixth display region may not overlap with each other.

The sixth display region can be the display region expanded by the display device in the first device form relative to the second device form, or the sixth display region can include the display region expanded by the display device in the first device form relative to the second device form, and the eighth display region. The eighth display region can be adjacent to the expanded display region in the display device.

For the specific implementations of units of embodiments of the present disclosure, reference can be made to the related content of the above specification, which is not described in detail.

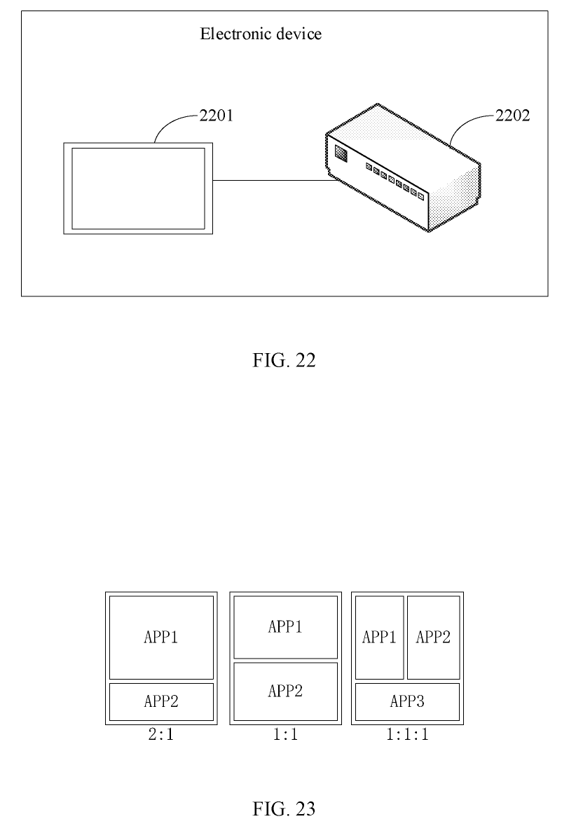

FIG. 22 is a schematic structural diagram of an electronic device according to some embodiments of the present disclosure. The electronic device includes a display device 2201 and a processor 2202.

The processor 2202, such as a CPU or GPU (graphics processing unit), can be configured to obtain the device form of the display device, and, in response to the first device form or the second device form of the display device, control the display device to be in the corresponding split-screen mode.

Under the split-screen mode, the display device can be divided into at least two display regions. The display region can be configured to display the application window. The first device form and the second device form can be different. The split-screen mode corresponding to the first device can be different from the split-screen mode corresponding to the second device form.

Based on the above technical solution, in the electronic device of embodiments of the present disclosure, the display device can be controlled to be in the corresponding split-screen mode according to the first device form or the second device form of the display device. Under the split-screen mode, the display device can be divided into at least two display regions. The display regions can be configured to display application windows. Since the first device form and the second device form are different, the split-screen mode corresponding to the first device form can be different from the split-screen mode corresponding to the second device form. Thus, in embodiments of the present disclosure, the dimension detection may not be needed, and the split-screen mode of the display device can be controlled according to the device form of the display device.

In some embodiments, the display device can at least include a first display screen and a second display screen. As shown in FIG. 2, the first display screen and the second display screen form the first device form or the second device form according to the change in the relative position.

The first region area can be greater than the second region area. The first region area can be the area of the display region of the display device under the first device form. The second region area can be the area of the display region of the display device under the second device form.

In some embodiments, as shown in FIG. 3, the second display screen can have a scroll structure. Under the second device form, the second display screen can be hidden in the housing of the scroll structure. Under the first device form, the first display screen and the second display screen can be visible.

In some embodiments, as shown in FIG. 4 or FIG. 5, the second display screen has a tablet structure. The second display screen and the first display screen are folded and connected. The second display screen is expanded relative to the first display screen under the first device form. The second display screen is folded relative to the first display screen under the second device form.

In some embodiments, the second display screen has a tablet structure as shown in FIG. 6. The second display screen and the first display screen have a stacked structure. The second display screen is blocked by the first display screen under the second device form. The second display screen can slide out relative to the first display screen under the first device form.

By taking the scroll screen as an example, the technical solution of the present disclosure is described below.

In the present disclosure, the relative state, i.e., the device form above, of the screen and the host can be monitored through cooperation of the software and hardware. Then, according to the relative state, the window layout can be dynamically adjusted, i.e., the split-screen mode. Thus, more window layout designs can be satisfied according to the device form to provide the user with a better experience.

In some embodiments, when the application of the present disclosure (i.e., the split-screen application) determines the predetermined layout of the upper layer application (App), the target instruction can be issued to the EC and BIOS at the bottom layer to detect the current roll-in and roll-out states. The state at the bottom layer can be returned to the split-screen application. The split-screen application can adjust the predetermined window layout template according to the state.

When the scroll screen is in the roll-out state, as shown in FIG. 23, APP1, APP2, and APP3 are in the current corresponding positions in different window ratios according to the corresponding window layout. The APP2 of the previous two window layouts and APP3 of the third window layout can be the split-screen application, which are always at the bottom region of the screen. One or more application windows are displayed in the constructed container.

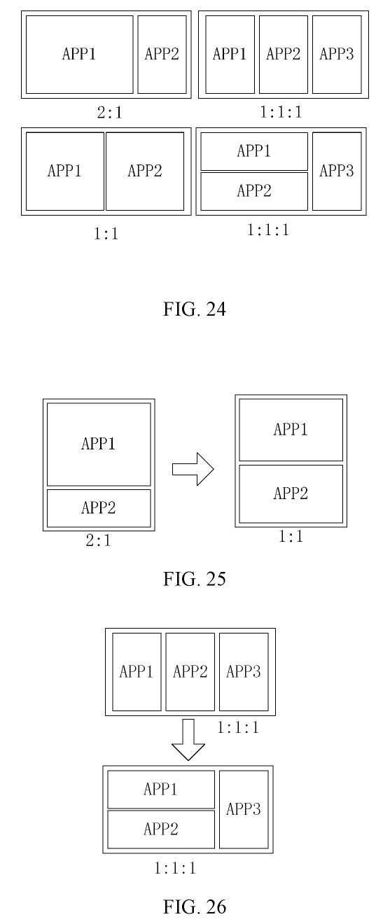

When the scroll screen is in the roll-in state, as shown in FIG. 24, APP1, APP2, and APP3 are displayed in the corresponding positions at different window ratios according to the corresponding window layout.

Further, in the split-screen application, one container window can be used to accommodate the application windows of various APPs displayed by the container window. When the size of the container window changes, the service corresponding to the container window can recalculate the dimensions of the plurality of APP windows in the container according to new positions. Related interfaces can be called to reconfigure the dimensions of the APP windows to adapt to the new layout.

As shown in FIG. 25, the region where App2 is located is the container region. In the container region, a setting button with a dynamically changed size is set. App2 is arranged in the container region.

For example, as shown in the layout of the left window in FIG. 25, when the user clicks the setting button, the container region receives the instruction for partial change. The dimensions of App1 and App2 are recalculated according to the ratio of the layout of the right window in FIG. 25. After the calculation, the service program running at the backend actively calls the window size setting interface of the operating system to set the sizes and positions of App1, App2, and container. Thus, the layout can be adjusted with one key to lower the user operation complexity.

In particular, the above is merely an example. In practice, the layout of 3 Apps windows may be involved. As shown in FIG. 26, with the technical solution of embodiments of the present disclosure, the layout adjustment through one key can be realized to lower the user operation complexity.

Embodiments of the present disclosure are described progressively. Each embodiment focuses on the differences from other embodiments, and the identical or similar parts among the embodiments can be referred to each other. For the apparatus disclosed in the embodiments, since the apparatus corresponds to the method disclosed in the embodiments, the description is relatively simple, and the related parts can refer to the description of the method section.

Those skilled in the art can further understand that the units and algorithm steps described in the examples of embodiments of the present disclosure can be implemented by electronic hardware, computer software, or a combination thereof. To clearly illustrate the interchangeability of hardware and software, the compositions and steps of each example have been generally described above according to functions. Whether these functions are executed by hardware or software depends on the specific application and design constraints of the technical solution. Those skilled in the art can implement the described functions in different methods for each specific application. However, such implementation should not be considered beyond the scope of the present disclosure.

The steps of the methods or algorithms of embodiments of the present disclosure can be implemented directly by hardware, software modules executed by a processor, or a combination thereof. The software modules can be stored in random access memory (RAM), memory, read-only memory (ROM), electrically programmable ROM, electrically erasable programmable ROM, registers, hard disks, removable disks, CD-ROMs, or any other form of storage medium known in the art.

The above description of embodiments of the present disclosure can allow those skilled in the art to implement or use the present disclosure. Various modifications to these embodiments can be apparent to those skilled in the art. The general principles defined in the present disclosure can be implemented in other embodiments without departing from the spirit or scope of the present disclosure. Therefore, the present disclosure is not limited to embodiments of the present disclosure but conforms to the widest scope consistent with the principles and novel features of the present disclosure.

What is claimed is:

1. A control method comprising:
obtaining a device form of a display device; and
in response to the display device being in a first device form or a second device form, controlling the display device to be in a corresponding split-screen mode;
wherein:
in the corresponding split-screen mode, the display device is divided into at least two display regions;
the display regions are configured to display application windows;
the first device form is different from the second device form; and
a split-screen mode corresponding to the first device form is different from a split-screen mode corresponding to the second device form.

2. The method according to claim 1, further comprising:
in response to a split-screen switching operation for a first application window, controlling the display device to switch from a first split-screen mode to a second split-screen mode, and switching the first application window from a first display region to a third display region for display;
wherein:
the first application window is an application window displayed in the first display region of the display device;
the first display region and at least one second display region of the display device form the first split-screen mode, and the at least one second display region displays a second application window;
in the second split-screen mode, the display device is divided into a third display region and at least one fourth display region; and
layout positions of at least two display regions between the first split-screen mode and the second split-screen mode are different; and
switching the second application window from the second display region to the fourth display region for display.

3. The method according to claim 1, further comprising:
in response to a trigger display operation for a third application window, displaying the third application window in at least a portion of a target display region;
wherein, the target display region in the display device satisfies at least one of:
the target display region displaying no application window;
a relative position of the target display region in the display device satisfying a position condition;
the relative position of the target display region in the display device corresponding to the trigger display operation; or
the target display region being different from a fifth display region in the display device, the fifth display region being configured to display an application window of the first application.

4. The method according to claim 3, wherein displaying the third application window in the at least a portion of the target display region includes:
displaying the third application window in an entire region of the target display region; or
displaying the third application window in a first subregion of the target display region, wherein a second subregion of the target display region is configured to display a fourth application window, and the fourth application window is an application window that is displayed in the target display region before the third application window is displayed.

5. The method according to claim 1, wherein:
when the display device is in the first device form, the display device is in a first split-screen mode;
in the first split-screen mode, the display device displays a sixth display region, and the sixth display region is configured to display an application window of a second application; and
an application window of the second application is configured to display at least one application window.

6. The method according to claim 5, further comprising:
in response to a layout switching operation for the first split-screen mode, controlling the display device to switch from a first window layout to a second window layout;
wherein:
a first layout position corresponds to a second layout position;
the first layout position is a layout position of the sixth display region in the first window layout; and
the second layout position is a layout position of the sixth display region in the second window layout.

7. The method according to claim 5, further comprising:
in response to an adjustment operation for the sixth display region, obtaining a region position of the adjusted sixth display region; and
adjusting a display position of each application window in the sixth display region according to the region position of the adjusted sixth display region; and
wherein the application windows cover the entire sixth display region, and the application windows do not overlap with each other.

8. The method according to claim 7, further comprising:
adjusting a region position of a seventh display region according to the region position of the sixth display region after adjustment;
wherein, the seventh display region is any display region of the display device other than the sixth display region; the seventh display region and the sixth display region together fully cover the display device, and the seventh display region and the sixth display region do not overlap with each other.

9. The method according to claim 5, wherein:
the sixth display region is a display region of the display device expanded in the first device form relative to the second device form; or
the sixth display region includes the display region expanded by the display device in the first device form relative to the second device form, and an eighth display region, the eighth display region being adjacent to the expanded display region in the display device.

10. An electronic device comprising:
a display device;
one or more processors; and
one or more memories storing a computer program that, when executed by the one or more processors, causes the one or more processors to:
obtain a device form of a display device; and
in response to the display device being in a first device form or a second device form, control the display device to be in a corresponding split-screen mode;
wherein:
in the corresponding split-screen mode, the display device is divided into at least two display regions;
the display regions are configured to display application windows;
the first device form is different from the second device form; and
a split-screen mode corresponding to the first device form is different from a split-screen mode corresponding to the second device form.

11. The electronic device according to claim 10, wherein:
the display device at least includes a first display screen and a second display screen forming the first device form or the second device form according to a change in the relative position of the first display screen and the second display screen;
an area of a first region is greater than an area of a second region;
the area of the first region is an area of a display region of the display device under the first device form; and
the area of the second region is an area of the display region of the display device under the second device form.

12. The electronic device according to claim 11, wherein:
the second display screen has a scroll structure, under the second device form, the second display screen is hidden in a housing of the scroll structure, and under the first device form, the first display screen and the second display screen are visible; or
the second display screen has a tablet structure, the second display screen is folded and connected to the first display screen, the second display screen is expanded relative to the first display screen under the first device form, and the second display screen is folded relative to the first display screen under the second device form; or
the second display screen has a tablet structure, the second display screen and the first display screen have a stacked structure, the second display screen is blocked by the first display screen under the second device form, and the second display screen slides out relative to the first display screen under the first device form.

13. The electronic device according to claim 10, wherein the one or more processors are further configured to:
in response to a split-screen switching operation for a first application window, control the display device to switch from a first split-screen mode to a second split-screen mode, and switch the first application window from a first display region to a third display region for display;
wherein:
the first application window is an application window displayed in the first display region of the display device;
the first display region and at least one second display region of the display device form the first split-screen mode, and the at least one second display region displays a second application window;
in the second split-screen mode, the display device is divided into a third display region and at least one fourth display region; and
layout positions of at least two display regions between the first split-screen mode and the second split-screen mode are different; and
switch the second application window from the second display region to the fourth display region for display.

14. The electronic device according to claim 10, wherein the one or more processors are further configured to:
in response to a trigger display operation for a third application window, display the third application window in at least a portion of a target display region;
wherein, the target display region in the display device satisfies at least one of:
the target display region displaying no application window;
a relative position of the target display region in the display device satisfying a position condition;
the relative position of the target display region in the display device corresponding to the trigger display operation; or
the target display region being different from a fifth display region in the display device, the fifth display region being configured to display an application window of the first application.

15. The electronic device according to claim 14, wherein the one or more processors are further configured to:
display the third application window in an entire region of the target display region; or
display the third application window in a first subregion of the target display region, wherein a second subregion of the target display region is configured to display a fourth application window, and the fourth application window is an application window that is displayed in the target display region before the third application window is displayed.

16. The electronic device according to claim 10, wherein:
when the display device is in the first device form, the display device is in a first split-screen mode;
in the first split-screen mode, the display device displays a sixth display region, and the sixth display region is configured to display an application window of a second application; and
an application window of the second application is configured to display at least one application window.

17. The electronic device according to claim 16, wherein the one or more processors are further configured to:
in response to a layout switching operation for the first split-screen mode, control the display device to switch from a first window layout to a second window layout;
wherein:
a first layout position corresponds to a second layout position;
the first layout position is a layout position of the sixth display region in the first window layout; and
the second layout position is a layout position of the sixth display region in the second window layout.

18. The electronic device according to claim 16, wherein the one or more processors are further configured to:
in response to an adjustment operation for the sixth display region, obtain a region position of the adjusted sixth display region; and
adjust a display position of each application window in the sixth display region according to the region position of the adjusted sixth display region; and
wherein the application windows cover the entire sixth display region, and the application windows do not overlap with each other.

19. The electronic device according to claim 18, wherein one or more processors are further configured to:
adjust a region position of a seventh display region according to the region position of the sixth display region after adjustment;
wherein, the seventh display region is any display region of the display device other than the sixth display region; the seventh display region and the sixth display region together fully cover the display device, and the seventh display region and the sixth display region do not overlap with each other.

20. A computer readable storage medium storing one more computer instructions, when executed by one or more processors, performing a control method comprising:
obtaining a device form of a display device; and
in response to the display device being in a first device form or a second device form, controlling the display device to be in a corresponding split-screen mode;
wherein:
in the corresponding split-screen mode, the display device is divided into at least two display regions;
the display regions are configured to display application windows;
the first device form is different from the second device form; and
a split-screen mode corresponding to the first device form is different from a split-screen mode corresponding to the second device form.
